(19) United States
(12) Patent Application Publication
(10) Pub. No.: US 2011/0229640 A1
(43) Pub. Date: Sep. 22, 2011

(54) FABRICATION METHOD OF CALCIUM CARBONATE THIN FILM WITH SHAPE-CONTROLLED FINESTRUCTURE PATTERN USING ADDITIVE

(75) Inventors: Seung-Woo LEE, Daejeon (KR); Young-Nam JANG, Dajeon (KR)

(73) Assignee: KOREA INSTITUTE OF GEOSCIENCE AND MINERAL RESOURCES, Daejeon (KR)

(21) Appl. No.: 12/786,479

(22) Filed: May 25, 2010

(30) Foreign Application Priority Data
Mar. 16, 2010 (KR) 2010-0023225

(51) Int. Cl. B05D 5/00

(52) U.S. Cl. 427/256

(57) ABSTRACT

Disclosed are a method for fabrication of a calcium carbonate thin film comprising adding a calcium agent to a container receiving an additive-dissolved water to dissolve calcium agent and leaving a mixture of the calcium agent and the additive in water for a predetermined period to form a calcium carbonate thin film with a shape-controlled finestructure pattern wherein the pattern is selected from nanostructure pattern, microstructure pattern and a combined nanostructure and microstructure pattern, and, in addition, a calcium carbonate thin film with a shape-controlled microstructure pattern formed by the foregoing method, a metallic film with a shape-controlled microstructure pattern which includes a template comprising the calcium carbonate thin film with a shape-controlled microstructure pattern formed by the foregoing method and a process for fabrication thereof, as well as a polymer with a shape-controlled microstructure pattern having the calcium carbonate thin film with a shape-controlled microstructure pattern formed by the foregoing method and a method for preparation thereof.

This application claims priority from Korean Patent Application No. 2010-0023225, filed on Mar. 16, 2010 in the Korean Intellectual Property Office, the entire disclosure of which is incorporated herein by reference.

### BACKGROUND OF THE INVENTION

1. Field of the Invention

The present invention relates to a method for fabrication of a calcium carbonate thin film with a shape-controlled finestructure pattern and, more particularly, to a method for fabrication of a calcium carbonate thin film, which includes adding a calcium agent to a container receiving an additive-dissolved water to dissolve calcium agent in the water; and leaving a mixture of the calcium agent and the additive in water for a predetermined period to form a calcium carbonate thin film having a fine structure pattern with controlled shape on a water surface wherein the pattern is selected from nanostructure pattern, microstructure pattern and a combined nanostructure and microstructure pattern; in addition, a calcium carbonate thin film with a shape-controlled finestructure pattern formed by the foregoing method; a metallic film with a shape-controlled finestructure pattern fabricated using the calcium carbonate thin film with a shape-controlled finestructure pattern formed by the foregoing method as a template and a process for fabrication of the metallic film; and a polymer with a shape-controlled finestructure pattern prepared using the calcium carbonate thin film with a shape-controlled finestructure pattern formed by the foregoing method and a method for preparation thereof.

2. Description of the Related Art

Since Bunsen and Grove initially prepared a thin film by chemical reaction and/or electrical discharge in 1852, thin film techniques have developed as an improved technology for practical embodiment of various electrical, optical and/or mechanical applications. Following this, after vacuum deposition was accomplished in 1950, a number of studies and investigations into such thin film techniques have been increasingly conducted.

The thin film technique is generally classified into a vapor phase method and a liquid phase method and, in particular, the vapor phase method may be divided into a physical vapor deposition (PVD) process wherein a raw material to be deposited is evaporated to convert into vapor by physical means and the vapor is deposited on a substrate to form the thin film, and a chemical vapor deposition (CVD) process wherein a raw material creates a reaction such as decomposition, chemical reaction and/or dissociation and the reaction product is deposited on a substrate to form the thin film. On the other hand, the liquid phase method includes plating, an anodic oxidation method, coating, or a sol-gel process, etc.

Since the thin film is typically synthesized under vacuum or in a nanostructure through chemical reaction between molecules, it is difficult to control a shape of the thin film if a size of the thin film is larger than a constant standard level. Under such circumstances, shape control of a thin film is recognized as a technique widely applicable to future material and/or electronic material industries.

Accordingly, the present invention provides: a method for fabrication of a calcium carbonate thin film with a variety of shape-controlled finestructure patterns using amino acid, monosaccharide and/or metal ion components in relation to crystal growth of calcium carbonate as additives; a calcium carbonate thin film with a shape-controlled finestructure pattern formed by the foregoing method; a metallic film with a shape-controlled finestructure pattern fabricated using the calcium carbonate thin film with a shape-controlled finestructure pattern formed by the foregoing method and a process for fabrication thereof; and a polymer with a shape-controlled finestructure pattern prepared using the calcium carbonate thin film with a shape-controlled finestructure formed by the foregoing method and a method for preparation thereof.

### SUMMARY OF THE INVENTION

It is a first object of present invention to provide a method for fabrication of a calcium carbonate thin film with a shape-controlled finestructure pattern.

A second object of the present invention is to provide a calcium carbonate thin film with a shape-controlled finestructure pattern formed by the foregoing method for fabrication thereof.

A third object of the present invention is to provide a process for fabrication of a metallic film with a shape-controlled finestructure pattern fabricated using the calcium carbonate thin film with a shape-controlled finestructure pattern formed by the foregoing method for fabrication of the calcium carbonate thin film and, in addition, the metallic film with a shape-controlled finestructure pattern fabricated by the same.

A fourth object of the present invention is to provide a method for preparation of a polymer with a shape-controlled finestructure pattern obtained using the calcium carbonate thin film with a shape-controlled finestructure pattern formed by the foregoing method for fabrication of the calcium carbonate thin film and, in addition, the polymer with a shape-controlled finestructure pattern prepared by the same.

In order to accomplish the above objects, there is provided a method for fabrication of a calcium carbonate thin film according to the present invention comprising: adding a calcium agent to a container receiving an additive-dissolved water to dissolve the same in the solution; and leaving a mixture of the calcium agent and the additive in water for a predetermined period to form a calcium carbonate thin film having a shape-controlled finestructure pattern on a surface of the water. In addition, a calcium carbonate thin film formed by the foregoing method may be provided.

The present invention may also provide a method for fabrication of a metallic film with a shape-controlled finestructure pattern comprising: applying a metallic film to the calcium carbonate thin film with a shape-controlled finestructure pattern formed by the foregoing method; and removing the calcium carbonate thin film from the metallic film coated on the calcium carbonate thin film to produce the metallic film with a shape-controlled finestructure pattern, as well as the metallic film with a shape-controlled finestructure pattern fabricated by the above process.

Additionally, the present invention may provide a method for fabrication of a polymer with a shape-controlled finestructure pattern, comprising: applying a polymer to the calcium carbonate thin film to form a shape-controlled finestructure pattern formed by the foregoing method, then, curing the same; and removing the calcium carbonate thin film from the polymer coated on the calcium carbonate thin film to produce the polymer with a shape-controlled finestructure pattern, as well as the polymer with a shape-controlled finestructure pattern prepared by the above method.

The calcium carbonate thin film provided according to the present invention may control a shape of a finestructure pattern and optionally control an area and/or a shape of the calcium carbonate thin film, thus being applicable as a template used in various material and/or electronic material industries.

The inventive method for fabrication of a calcium carbonate thin film with a shape-controlled finestructure pattern requires relatively simple synthesis equipment and process at ambient conditions (25° C. and 1 atm.), compared to existing synthesis process of a thin film with controlled shape. Therefore, a thin film may be fabricated with reduced processing costs, a surface shape and/or structure of the thin film may be easily controlled, and a thin film with desired area and/or shape may be preferably fabricated. Moreover, for synthesis of a calcium carbonate thin film with a shape-controlled finestructure pattern, since waste resource such as shell can be used as a calcium agent which is a raw material of the calcium carbonate thin film, the inventive method may have various advantages such as environmental benefit, cost reduction, and the like, thereby being effectively utilized as an original technology in biomaterials industry.

With regard to manufacture of a template based on a typical wet etching process, a photo-sensitive film such as photoresist is required and several processes including, for example, coating of photoresist, exposure on a mask, chemical treatment in a wet etching solution, etc. are also demanded. Therefore, high processing costs and expensive equipment are necessary for conventional methods to manufacture a template. In contrast, the present invention adopts use of an additive with a constant amount at room temperature and atmospheric pressure and a desired maintaining time, so as to form a shape-controlled finestructure pattern on a surface of a calcium carbonate thin film. According to the present invention, the calcium carbonate thin film may be easily removed using acid on the basis of inherent characteristics of the calcium carbonate.

The calcium carbonate thin film formed according to the present invention may be employed in various applications including, for example, a method for fabrication of a metallic film with a shape-controlled finestructure pattern as well as a method for fabrication of a polymer with a shape-controlled finestructure pattern, both of which include use of the calcium carbonate thin film having a shape-controlled finestructure pattern formed as described above. Such metallic film and polymer having shape-controlled finestructure patterns, respectively, produced as described above may be employed in various material industries.

### BRIEF DESCRIPTION OF THE DRAWINGS

The above and other objects, features and other advantages of the present invention will be more clearly understood from the following detailed description taken in conjunction with the accompanying drawings, in which:

FIG. 1(a) is a scanning electron microscope (SEM) photograph showing a calcium carbonate thin film with a shape-controlled finestructure pattern formed according to Example 1 of the present invention, FIG. 1(b) is an SEM photograph showing a calcium carbonate thin film with a shape-controlled finestructure pattern formed according to Example 2 of the present invention, FIG. 1(c) is an SEM photograph showing a calcium carbonate thin film with a shape-controlled finestructure pattern formed according to Example 3 of the present invention, FIG. 1(d) is an SEM photograph showing an enlarged region of FIG. 1(c), FIG. 1(e) is an SEM photograph showing a calcium carbonate thin film with a shape-controlled finestructure pattern formed according to Example 4 of the present invention, and FIG. 1(f) is an SEM photograph showing a calcium carbonate thin film with a shape-controlled finestructure pattern formed according to Example 5 of the present invention;

FIG. 2(a) is a graph illustrating X-ray diffraction assay results of the calcium carbonate thin film with a shape-controlled finestructure pattern formed according to Example 4 of the present invention, and FIG. 2(b) is a graph illustrating X-ray diffraction assay results of the calcium carbonate thin film with a shape-controlled finestructure pattern formed according to Example 1 of the present invention;

FIG. 3(a) schematically illustrates a process for fabrication of a metallic film or for preparation of a polymer with a shape-controlled finestructure pattern using the calcium carbonate thin film with a shape-controlled finestructure pattern, and FIG. 3(b) shows different forms of the fabricated metallic film with a shape-controlled finestructure pattern or the prepared polymer with a shape-controlled finestructure pattern according to the process shown in FIG. 3(a); and

FIG. 4(a) is an SEM photograph illustrating analysis results of a surface of an Au film which was fabricated by applying the Au film to a calcium carbonate thin film having a shape-controlled finestructure pattern and removing the calcium carbonate thin film from the coated Au film, and FIG. 4(b) is an SEM photograph illustrating analysis results of a surface of a polymer which was prepared by applying polymer polydimethylsiloxane (PDMS) to a calcium carbonate thin film having a shape-controlled finestructure pattern and removing the calcium carbonate thin film from the coated polymer.

### DETAILED DESCRIPTION OF THE INVENTION

Hereinafter, preferred embodiments of the present invention will be described in more detail through the following examples, in conjunction with the accompanying drawings.

According to an exemplary embodiment of the present invention, a method for fabrication of a calcium carbonate with a shape-controlled finestructure pattern is provided.

More particularly, the exemplary embodiment describes a method for fabrication of a calcium carbonate with a shape-controlled finestructure pattern comprising: adding a calcium agent to a container receiving an additive-dissolved water to dissolve calcium agent in the water; and leaving a mixture of the calcium agent and the additive in water for a predetermined period to form a calcium carbonate thin film having a shape-controlled finestructure pattern on a surface of the water.

The mixture of the calcium agent and additive in water may be left in air at 3 to 35° C. under 0.5 to 2 atm for 10 minutes to 30 days.

The mixture of the calcium agent and additive in water is preferably left in air at normal temperature and pressure for 10 minutes to 30 days.

As such, by maintaining the mixture of the calcium agent and additive in water in air at 3 to 35° C. under 0.5 to 2 atm or at room temperature and atmospheric pressure for 10 minutes to 30 days, a calcium carbonate component is spontaneously suspended on a surface of water by the calcium agent and calcium carbonate crystals are uniformly grown over time, thus generating a calcium carbonate thin film on the water surface.

A container receiving a solution of additive in water may be desirably selected and used, in order to form a calcium carbonate thin film having a shape-controlled finestructure pattern with different areas. That is, adjusting an area of the container could produce a calcium carbonate thin film having a shape-controlled finestructure pattern with varied areas.

A shape of the container receiving a solution of additive in water could be desirably selected in order to produce different forms of calcium carbonate thin films. For instance, if the container has a cross-sectional shape selected from sphere, ellipse, polygons having 3 to 12 sides and star shape, a calcium carbonate thin film in any one form selected from sphere, ellipse, polygons having 3 to 12 sides and star shape, could be successfully obtained.

As a precursor for the calcium carbonate thin film of the present invention, a calcium agent could be used.

Such calcium agent may be shells.

Alternatively, the calcium agent may be heated shells. For instance, heating the shell at 600 to 700° C. for 1 to 72 hours and, preferably, at 650° C. for 24 hours, then the treated shell may be used.

The calcium agent may be calcium oxide.

The calcium agent may be calcium hydroxide.

The calcium agent may be a mixture of two or more selected from shell, heated shell, calcium oxide and calcium hydroxide.

When using the mixture of two or more selected from shell, heated shell, calcium oxide and calcium hydroxide, respective components in the mixture may be admixed in equal ratios by mass.

The additive used in the present invention could control a shape of the finestructure pattern formed on a surface of the calcium carbonate thin film.

According to types and/or concentration of the additive, the shape of the finestructure pattern formed on a surface of the calcium carbonate thin film may be controlled.

The additive for controlling a shape of the finestructure pattern formed on a surface of the calcium carbonate thin film may comprise amino acid.

Alternatively, the additive for controlling a shape of the finestructure pattern formed on a surface of the calcium carbonate thin film may comprise saccharide.

The additive for controlling a shape of the finestructure pattern formed on a surface of the calcium carbonate thin film may comprise metal ions.

When using amino acid and metal ions as the additive, nanostructure pattern may be advantageously obtained. On the other hand, saccharide may be suitable to form a microstructure pattern. However, the additive for formation of a nanostructure pattern is not particularly limited to amino acid and metal ions. Likewise, the additive for formation of a microstructure pattern is not particularly limited to saccharide. More particularly, some may be preferably selected among various additives described above so as to control a shape of any one selected nanostructure pattern, microstructure pattern and a combined nanostructure and microstructure pattern.

The additive for controlling a shape of the finestructure pattern formed on a surface of the calcium carbonate thin film described above may include two or more selected from amino acid, saccharide and metal ions and, in this case, two or more components of the additive may be admixed in equal concentrations when dissolved in water.

Amino acid used in the additive may be at least one selected from glycine, alanine, arginine, asparagine, aspartate, cysteine, glutamate, glutamine, histidine, praline, serine, tyrosine, isoleucine, leucine, lysine, tryptophan, valine, methionine, phenylalanine and threonine, wherein the amino acid is dissolved in water to maintain a concentration of 0.001 to 10M in order to control a shape of a finestructure pattern formed on a surface of a calcium carbonate thin film, in turn having any one selected from a nanostructure pattern in an embossed plate or spherical shape, a finestructure pattern, and/or a combination of such nanostructure pattern and microstructure pattern.

Among such additives, saccharide may be monosaccharide and/or disaccharide wherein the saccharide is dissolved in water to maintain a concentration of 0.001 to 10M in order to control a shape of a finestructure pattern formed on a surface of a calcium carbonate thin film, in turn having any one selected from a nanostructure pattern in a small pebble stone shape, a finestructure pattern, and/or a combination of such nanostructure pattern and microstructure pattern.

Such monosaccharide used in the saccharide additive may be at least one selected from glucose, fructose, galactose, mannose and ribose, while disaccharide may be at least one selected from sucrose, maltose and lactose.

Metal ions used in the additive may include any one to be dissolved in water and, in this case, the metal ions are dissolved in water to maintain a concentration of 0.001 to 10M in order to control a shape of a finestructure pattern formed on a calcium carbonate thin film, in turn having any one selected from a nanostructure pattern in a chestnut bur and/or a streusel bread shape, a microstructure pattern and/or a combination of such nanostructure pattern and microstructure pattern.

Such metal ions used in the additive may comprise at least one selected from Na, Mg, K and Li ions.

The finestructure pattern with controlled shape formed on a surface of the calcium carbonate thin film of the present invention may be at least one selected from nanostructure pattern, microstructure pattern and a combination of nanostructure pattern and microstructure pattern.

The present invention may comprise a calcium carbonate thin film with a shape-controlled finestructure pattern formed by the method described above.

The present invention could include a calcium carbonate thin film having at least one shape-controlled finestructure pattern selected from a nanostructure pattern, a microstructure pattern and a combination of nanostructure pattern and microstructure pattern formed by the foregoing method.

The present invention could include a metallic film and/or polymer with a shape-controlled finestructure pattern as fabricated using the calcium carbonate thin film with a shape-controlled finestructure pattern formed by the foregoing method, wherein the finestructure pattern of the metallic film and/or polymer is substantially the same as of the calcium carbonate thin film.

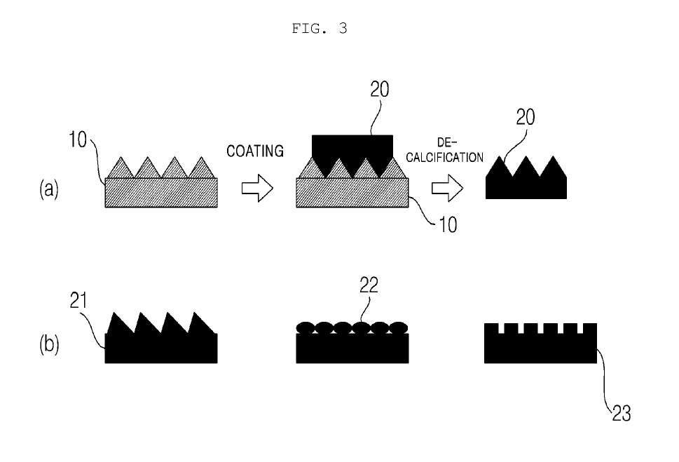

In other words, as shown in FIG. 3(a), it is possible to produce a metallic film and/or polymer 20 with a shape-controlled finestructure pattern by applying a metallic film and/or polymer 20 to a calcium carbonate thin film 10 with a shaped-controlled finestructure pattern, then, removing the calcium carbonate thin film 10, wherein the microstructure pattern of the metallic film and/or polymer 20 is substantially the same as of the calcium carbonate thin film. FIG. 3(b) shows metallic films and/or polymers 21, 22, 23 with a shape-controlled microstructure pattern in different forms obtained as shown in FIG. 3(a).

The present invention could include a method for fabrication of a metallic film with a shape-controlled microstructure pattern using the calcium carbonate thin film with a shape-controlled finestructure pattern formed by the foregoing method, and a metallic film having a shape-controlled finestructure pattern fabricated by the foregoing method.

More particularly, the present invention could include a method for fabrication of a metallic film with a shape-controlled finestructure pattern comprising: applying a metallic film to the calcium carbonate thin film having a shape-controlled finestructure pattern formed by the method described above; and removing the calcium carbonate thin film from the metallic film applied on the calcium carbonate thin film to form a metallic film with a shape-controlled finestructure pattern, as well as the metallic film with a shape-controlled finestructure pattern fabricated by the forgoing method.

In the foregoing process for fabrication of a metallic film having a shape-controlled finestructure pattern, the metallic film may be a film comprising at least one metal selected from a group consisting of alkali metal, alkali-earth metal and transition metal.

In the foregoing process for fabrication of a metallic film having a shape-controlled finestructure pattern, the metallic film could be a film comprising at least one metal selected from a group consisting of Au, Li, Mg, Sr, Ba, Zn and Ag.

In the foregoing process for fabrication of a metallic film having a shape-controlled finestructure pattern, the metallic film coated on the calcium carbonate thin film could be subjected to acid treatment to remove the calcium carbonate thin film.

In the foregoing process for fabrication of a metallic film having a shape-controlled finestructure pattern, the metallic film coated on the calcium carbonate thin film could be subjected to acid treatment using weak acid to remove the calcium carbonate thin film.

In the foregoing process for fabrication of a metallic film having a shape-controlled finestructure pattern, the metallic film coated on the calcium carbonate thin film could be subjected to acid treatment using acetic acid or ethylenediamine tetraacetic acid (EDTA) to remove the calcium carbonate thin film.

The present invention could include a method for fabrication of a polymer with a shape-controlled finestructure pattern using the calcium carbonate thin film formed by the foregoing method, as well as the polymer having a shape-controlled finestructure pattern prepared by the same.

The above method for preparation of a polymer with a shape-controlled finestructure pattern comprises: applying the polymer to the calcium carbonate thin film having a shape-controlled finestructure pattern formed by the foregoing method, then, curing the coated thin film; and removing the calcium carbonate thin film from the polymer applied on the calcium carbonate thin film to form a polymer with a shape-controlled finestructure pattern, as well as the polymer with a shape-controlled finestructure pattern prepared by the same.

In the foregoing method for preparation of a polymer having a shape-controlled finestructure pattern, the polymer could include at least one selected from a group consisting of polydimethylsiloxane, polyethylene, polypropylene, polyurethane, polyvinylchloride, epoxy, polystyrene and polyester.

In the foregoing method for preparation of a polymer having a shape-controlled finestructure pattern, the polymer coated on the calcium carbonate thin film could be subjected to acid treatment to remove the calcium carbonate thin film.

In the foregoing method for fabrication of a polymer having a shape-controlled finestructure pattern, the polymer coated on the calcium carbonate thin film could be subjected to acid treatment using weak acid to remove the calcium carbonate thin film.

In the foregoing method for fabrication of a polymer having a shape-controlled finestructure pattern, the polymer coated on the calcium carbonate thin film could be subjected to acid treatment using acetic acid to remove the calcium carbonate thin film.

As described above, the foregoing objects of the present invention including, for example: a method for fabrication of a calcium carbonate thin film having a shape-controlled finestructure pattern, and a calcium carbonate thin film with a shape-controlled finestructure pattern formed by the same; a process for fabrication of a metallic film with a shape-controlled finestructure pattern using the calcium carbonate thin film with a shape-controlled finestructure pattern formed by the foregoing method, and a metallic film having a shape-controlled finestructure pattern fabricated by the same; and a method for preparation of a polymer with a shape-controlled finestructure pattern using the calcium carbonate thin film with a shape-controlled finestructure formed by the foregoing method, and a polymer having a shape-controlled finestructure pattern prepared by the same, have been executed under various conditions and, in order to accomplish such objects, the present invention could be conducted under desired conditions as described above.

Preferred embodiments of the present invention will be described by the following examples and experimental examples. However, such embodiments are provided for illustrative purposes but are not construed to restrict the scope of the present invention as defined by the appended claims.

### Example 1

Water (1 liter) was poured into a container having a spherical cross-section, aspartate was added thereto and admixed for 1 minute in order to dissolve the same and obtain an aspartate solution with a concentration of 50 mM in water, followed by addition of 50 g calcium hydroxide and stirring the mixture for 2 minutes.

The container receiving aspartate and calcium hydroxide in water was left in air at room temperature and atmospheric pressure for 1 day to form a calcium carbonate thin film having a finestructure pattern on a surface thereof.

The calcium carbonate thin film formed as described above was subjected to shape analysis using an SEM at an accelerated voltage of 1015 kv.

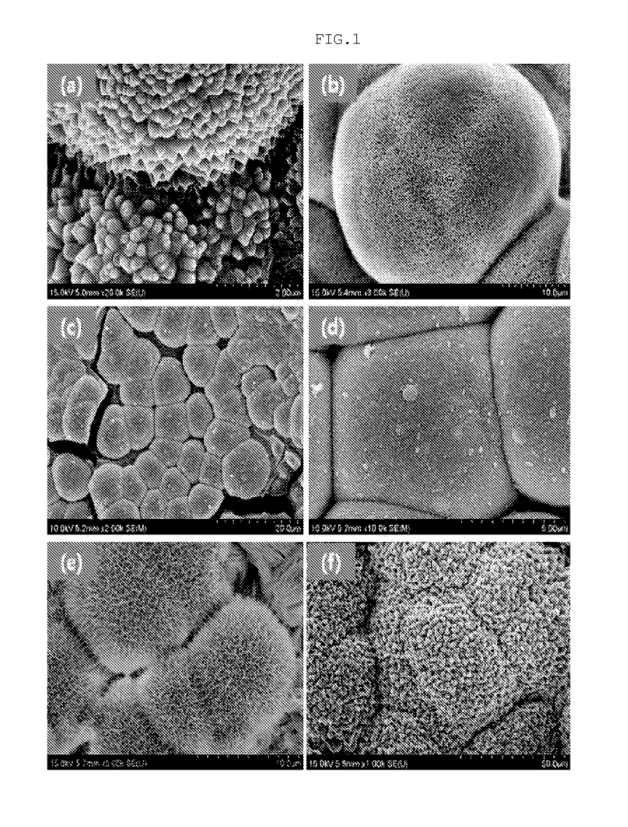

FIG. 1(a) is an SEM photograph showing a part of a calcium carbonate thin film coming into contact with water in regard to the calcium carbonate thin film having a finestructure pattern formed on a surface thereof, which was formed by the foregoing method. From the photograph, it was found that the thin film has a sharp structure comprising particles with a size of 200 nm.

### Example 2

Water (1 liter) was poured into a container having a spherical cross-section, serine was added thereto and admixed for 1 minute in order to dissolve the same and obtain a serine solution with a concentration of 25 mM in water, followed by addition of 50 g calcium hydroxide and stirring the mixture for 2 minutes.

The container receiving serine and calcium hydroxide in water was left in air at room temperature and atmospheric pressure for 1 day to form a calcium carbonate thin film having a finestructure pattern on a surface thereof.

The calcium carbonate thin film formed as described above was subjected to shape analysis using an SEM at an accelerated voltage of 1015 kv.

FIG. 1(b) is an SEM photograph showing a part of a calcium carbonate thin film coming into contact with water in regard to the calcium carbonate thin film having a finestructure pattern formed on a surface thereof, which was formed by the foregoing method. From the photograph, it was found that the thin film has a spherical structure in a size of 20 to 30 μm including a few hundred nano-scale pores.

### Example 3

Water (1 liter) was poured into a container having a spherical cross-section, glucose was added thereto and admixed for 1 minute in order to dissolve the same and obtain a glucose solution with a concentration of 0.01 M in water, followed by addition of 50 g calcium hydroxide and stirring the mixture for 2 minutes.

The container containing glucose and calcium hydroxide in water was left in air at room temperature and atmospheric pressure for 1 day to form a calcium carbonate thin film having a finestructure pattern on a surface thereof.

The calcium carbonate thin film formed as described above was subjected to shape analysis using an SEM at an accelerated voltage of 1015 kv.

FIG. 1(c) is an SEM photograph showing a part of a calcium carbonate thin film coming into contact with water in regard to the calcium carbonate thin film having a finestructure pattern formed on a surface thereof, which was formed by the foregoing method. FIG. 1(d) is an enlarged photograph of FIG. 1(c) and showed that the thin film has a structure including a close arrangement of particles in a particle size of about 10 μm.

### Example 4

Water (1 liter) was poured into a container having a spherical cross-section, magnesium chloride was added thereto and admixed for 1 minute in order to dissolve the same and obtain a magnesium chloride solution with a concentration of 50 mM in water, followed by addition of 50 g calcium hydroxide and stirring the mixture for 2 minutes.

The container receiving magnesium chloride and calcium hydroxide in water was left in air at room temperature and atmospheric pressure for 1 day to form a calcium carbonate thin film having a finestructure pattern on a surface thereof.

The calcium carbonate thin film formed as described above was subjected to shape analysis using an SEM at an accelerated voltage of 1015 kv.

FIG. 1(e) is an SEM photograph showing a part of a calcium carbonate thin film coming into contact with water in regard to the calcium carbonate thin film having a finestructure pattern formed on a surface thereof, which was formed by the foregoing method. From the photograph, it was found that the thin film has a structure in a chestnut bur shape comprising units in a unit size of about 1 μm.

### Example 5

Water (1 liter) was poured into a container having a spherical cross-section, potassium chloride was added thereto and admixed for 1 minute in order to dissolve the same and obtain a potassium chloride solution with a concentration of 25 mM in water, followed by addition of 50 g calcium hydroxide and stirring the mixture for 2 minutes.

The container receiving potassium chloride and calcium hydroxide in water was left in air at room temperature and atmospheric pressure for 1 day to form a calcium carbonate thin film having a finestructure pattern on a surface thereof.

The calcium carbonate thin film formed as described above was subjected to shape analysis using an SEM at an accelerated voltage of 1015 kv.

FIG. 1(f) is an SEM photograph showing a part of a calcium carbonate thin film coming into contact with water in regard to the calcium carbonate thin film having a finestructure pattern formed on a surface thereof, which was formed by the foregoing method. From the photograph, it was found that the thin film has a structure comprising a combination of particles in a particle size of about 5 μm.

### Experimental Example

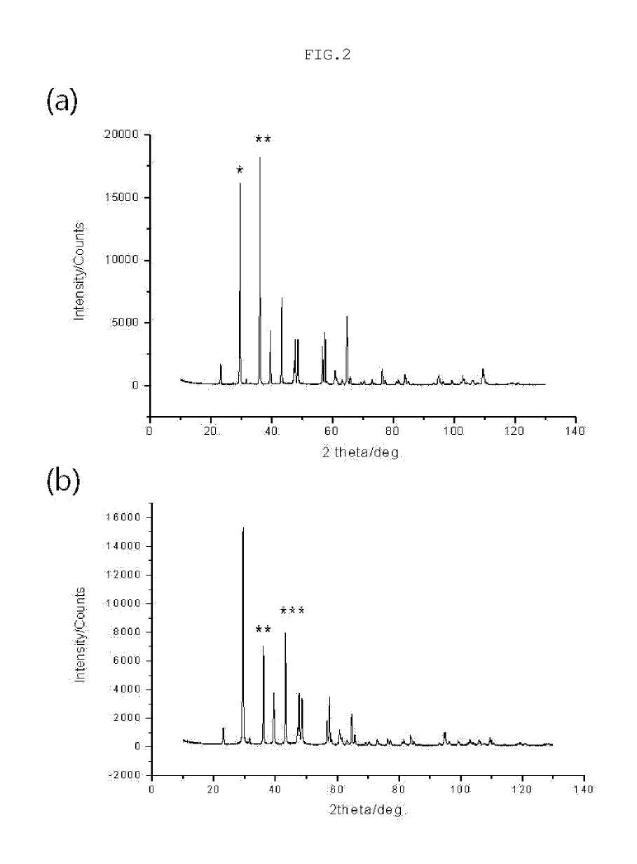

As a result of assaying crystal phases of the calcium carbonate thin film formed in Example 4 and the calcium carbonate thin film formed in Example 1, using an X-ray diffraction analyzer (D/MAX-IIIC, RIGAKU), at 40 kV and 45 mA, it can be seen that the synthesized thin film has a structure of calcite CaCO₃ which is known as a thermodynamically stable calcium carbonate phase (see FIG. 2).

However, as shown in FIG. 2, it can be seen that crystalline phases of the calcite are varied depending on types of additives used for production of a calcium carbonate thin film. For instance, for a crystalline phase of the calcium carbonate thin film formed using magnesium chloride as the additive in Example 4, (110) face (** in FIG. 2(a)) was more developed than (104) face as a main peak of the calcite (* in FIG. 2(a)). On the other hand, for a crystalline phase of the calcium carbonate thin film formed using aspartate as the additive in Example 1, a size of (110) face (** in FIG. 2(b)) was controlled to be substantially identical to that of (113) face (*** in FIG. 2(b)).

### Application Example 1

An Au film with a thickness of 100 nm was applied to the calcium carbonate thin film having a shape-controlled finestructure pattern formed in Example 3 by vacuum spraying, and the calcium carbonate thin film and calcium compound were removed by acid treatment using 10 wt. % acetic acid to produce an Au film with a shape-controlled finestructure pattern.

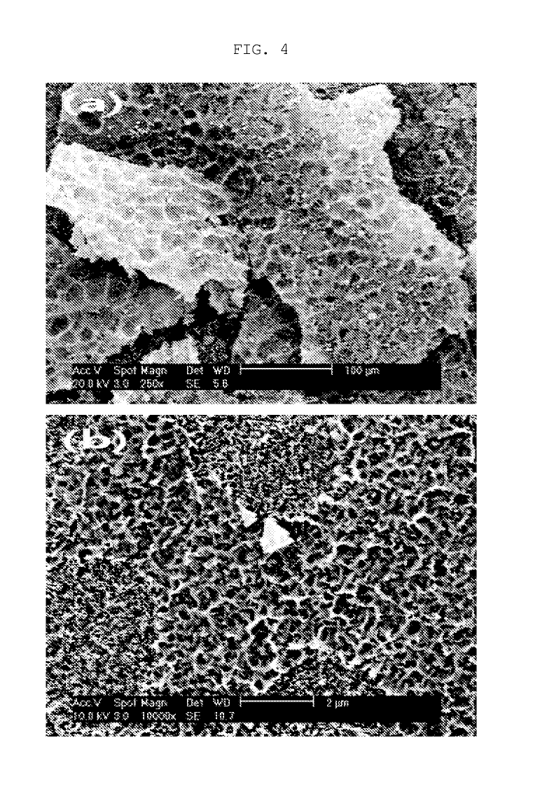

A cross-section of the Au film having a shape-controlled finestructure pattern was subjected to SEM analysis and an SEM photograph thereof is shown in FIG. 4(a).

As shown in FIG. 4(a), the Au film had a structure including a close arrangement of particles in a particle size of about 10 μm and it was found that the finestructure pattern of the calcium carbonate thin film formed in Example 3 was replicated on the Au film.

As an energy dispersion type X-ray analysis (EDX) result of cross-section shape of the above Au film (see FIG. 4(a) and TABLE 1), it can be seen that the coated film mostly comprises Au except a small amount of calcium.

TABLE 1
EDX results of cross-section shape of Au film

| Element | Oxygen | Au | Ca | Total |
|---|---|---|---|---|
| Content (wt. %) | 26.1 | 72.2 | 1.7 | 100 |

### Application Example 2

Polydimethylsiloxane (PDMS) was spray coated on the calcium carbonate thin film having a shape-controlled finestructure pattern formed in Example 4 and hardened for a constant time, then the calcium carbonate thin film and calcium compound were removed by acid treatment using 10 wt. % acetic acid and the remaining PDMS surface was observed by the SEM and its result is shown in FIG. 4(b).

As shown in FIG. 4(b), it was found that a number of units in a unit size of about 1 μm of the calcium carbonate thin film having a shape-controlled finestructure pattern in a chestnut bur shape were reproduced on the PDMS surface to form a porous structure with a pore size of about 1 μm. As a result, it can be seen that the shape-controlled finestructure pattern of the calcium carbonate was directly formed on a surface of the polymer, in turn producing the polymer with a shape-controlled fin eostructure pattern.

Magnification and massive processing of thin films are currently extended into energy applications such as photoelectric conversion element, thermoelectric conversion element, etc. A vapor phase method as a conventional thin film synthesis method requires a template in the form of a large thin film, in order to synthesize a thin film having a finestructure pattern. Also, a liquid phase method has difficulties in control of molecular structure. Accordingly, a calcium carbonate thin film having a shape-controlled finestructure pattern according to the present invention could be hereinafter employed as a substrate material and/or template applicable to various material industries such as electronic material and/or energy material industries.

While the present invention has been described with reference to preferred embodiments, it will be understood by those skilled in the art that various modifications and variations could be made therein without departing from the scope of the present invention as defined by the appended claims.

What is claimed is:

1. A method for fabrication of a calcium carbonate thin film comprising:
adding a calcium agent to a container receiving an additive-dissolved water to dissolve the calcium agent in the water; and
leaving a mixture of the calcium agent and the additive in water for a predetermined period to form a calcium carbonate thin film with a shape-controlled finestructure pattern on a surface of the water.

2. The method according to claim 1, wherein the mixture of the calcium agent and the additive in water is left in air at room temperature and customary pressure for 10 minutes to 30 days.

3. The method according to claim 1, wherein the container receiving the additive-dissolved water has at least one cross-sectional shape selected from a group consisting of sphere, ellipse, polygons having 3 to 12 sides and star shape.

4. The method according to claim 1, wherein the calcium agent is at least one selected from a group consisting of shell, heated shell, calcium oxide and calcium hydroxide.

5. The method according to claim 1, wherein the additive is at least one amino acid selected from a group consisting of glycine, alanine, arginine, asparagine, aspartate, cysteine, glutamate, glutamine, histidine, praline, serine, tyrosine, isoleucine, leucine, lysine, tryptophan, valine, methionine, phenylalanine and threonine and the additive is maintained in a solution state in water at a concentration of 0.001 to 10 M.

6. The method according to claim 1, wherein the additive is at least one saccharide selected from a group consisting of glucose, fructose, galactose, mannose and ribose, disaccharide selected from sucrose, maltose and lactose, and the additive is maintained in a solution state in water at a concentration of 0.001 to 10 M.

7. The method according to claim 1, wherein the additive is at least one metal ion selected from a group consisting of Na, Mg, K and Li ions and the additive is maintained in a solution state in water at a concentration of 0.001 to 10 M.

8. A method for fabrication of a metallic film with a shape-controlled finestructure pattern comprising:
applying a metallic film to the calcium carbonate thin film with a shape-controlled finetructure pattern formed by the method according to claim 1, wherein the metallic film comprises at least one metal selected from a group consisting of Au, Li, Mg, Sr, Ba, Zn and Ag; and
removing the calcium carbonate thin film from the metallic film applied on the calcium carbonate thin film to form a metallic film with a shape-controlled finestructure pattern.

9. A method for fabrication of a polymer with a shape-controlled finestructure pattern comprises:
applying the polymer to the calcium carbonate thin film with a shape-controlled finestructure pattern formed by the method according to claim 1 followed by curing the applied calcium carbonate thin film, wherein the polymer comprises at least one selected from a group consisting of polydimethylsiloxane, polyethylene, polypropylene, polyurethane, polyvinylchloride, epoxy, polystyrene and polyester; and
removing the calcium carbonate thin film from the polymer applied on the calcium carbonate thin film to form a polymer with a shape-controlled finestructure pattern.
